(19) United States
(12) Patent Application Publication
(10) Pub. No.: US 2022/0291249 A1
(43) Pub. Date: Sep. 15, 2022

(54) AUTOMATIC ANALYZING APPARATUS AND AUTOMATIC ANALYZING METHOD

(71) Applicant: Canon Medical Systems Corporation, Otawara-shi (JP)

(72) Inventor: Tatsuya MURATA, Otawara (JP)

(73) Assignee: Canon Medical Systems Corporation, Otawara-shi (JP)

(21) Appl. No.: 17/653,924

(22) Filed: Mar. 8, 2022

(30) Foreign Application Priority Data
Mar. 9, 2021 (JP) 2021-037600

(51) Int. Cl. G01N 35/10

(52) U.S. Cl. CPC G01N 35/1011; G01N 35/1079; G01N 2035/1013

(57) ABSTRACT

According to one embodiment, an automatic analyzing apparatus includes a piercer, a detector unit, and a sample dispensing probe. The piercer pierces a lid that seals an opening of a sample container containing a sample. The detector unit detects the piercer penetrating through the lid. The sample dispensing probe passes through an inside of the piercer that has penetrated through the lid, enters the sample container, and aspirates the sample.

### CROSS-REFERENCE TO RELATED APPLICATIONS

This application is based upon and claims the benefit of priority from Japanese Patent Application No. 2021-037600, filed Mar. 9, 2021, the entire contents of which are incorporated herein by reference.

### FIELD

Embodiments described herein relate generally to an automatic analyzing apparatus and an automatic analyzing method.

### BACKGROUND

An automatic analyzing apparatus handles test items such as biochemical test items, immunoserological test items, and blood test items, and is adapted to dispense a sample and a reagent into a reaction container to optically measure the reaction that takes place in the mixture liquid of the sample and the reagent. The automatic analyzing apparatus thus generates analysis data expressed as concentrations, enzyme activities, etc. of ingredients contained in the sample, for the respective test items.

The automatic analyzing apparatus uses a sample dispensing probe to dispense a sample from the inside of a sample container into a reaction container. Sample containers intended to be set in the automatic analyzing apparatus include a type which has an opening sealed with a lid, such as blood collection tubes. Sample containers of this type do not permit the sample dispensing probe to enter them, and accordingly, the automatic analyzing apparatus is often equipped with a tubular piercer needle for making a hole in the lid.

The automated analyzer moves the piercer needle downwards from above a sample container and stops the piercer needle at a predetermined height after it penetrates the lid of the sample container. Subsequently, the sample dispensing probe is allowed to move inside the tubular piercer needle so as to aspirate a sample within the sample container.

However, when a sample container contains a large amount of sample, the piercing action of the piercer needle, which first pushes the lid and pressurizes the inside of the sample container, could cause the sample to rush into the piercer needle once the lid is penetrated by the piercer needle and to spatter out of the sample container. Thus, great care must be taken when storing a sample in the sample container for test operations.

### BRIEF DESCRIPTION OF THE DRAWINGS

FIG. 1 is a block diagram showing a configuration of an automatic analyzing apparatus according to an embodiment.

FIG. 2 is a perspective view showing an exemplary structure of an analyzer unit according to the embodiment.

FIG. 3 is a diagram showing an exemplary structure of a piercer unit according to the embodiment.

FIG. 4 is a flowchart showing operations of the piercer unit according to the embodiment.

FIG. 5 includes illustrations showing positions of a piercer according to the embodiment.

### DETAILED DESCRIPTION

In general, according to one embodiment, an automatic analyzing apparatus includes a piercer, a detector unit, and a sample dispensing probe. The piercer pierces a lid that seals an opening of a sample container containing a sample. The detector unit detects the piercer penetrating through the lid. The sample dispensing probe passes through an inside of the piercer that has penetrated through the lid, enters the sample container, and aspirates the sample.

Embodiments will be described with reference to the drawings.

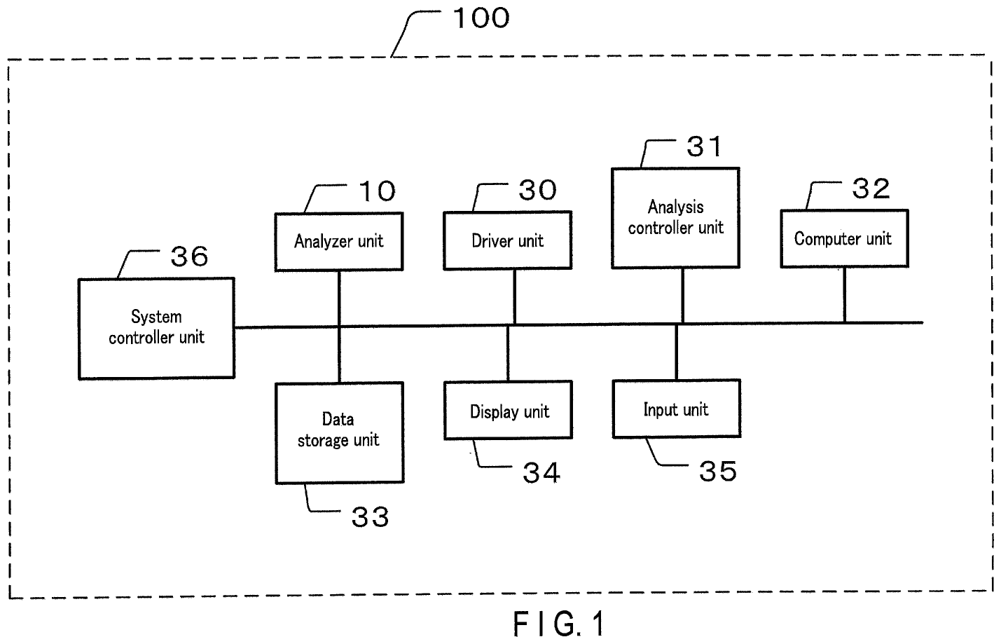

FIG. 1 is a block diagram showing a configuration of the automatic analyzing apparatus according to the embodiment. This automatic analyzing apparatus, denoted by reference number “100”, includes an analyzer unit 10 for dispensing a sample, which may be a standard sample for an intended test item or a subject sample, and a reagent for the test item, and subjecting the mixture liquid of the sample and the reagent to measurement operations. The automatic analyzing apparatus 100 also includes a driver unit 30 for driving multiple components in the analyzer unit 10 to perform aspiration, etc. for each sample and each reagent, and an analysis controller unit 31 for controlling the driver unit 30.

The automatic analyzing apparatus 100 includes a computer unit 32 for preparing a calibration curve from standard data that has been generated by the analyzer unit 10 through measurement of a mixture liquid of a standard sample and a reagent for an intended test item, and for generating, using the calibration curve for the test item, analysis data from subject data that has been generated through measurement of a mixture liquid of a subject sample and the reagent. The automatic analyzing apparatus 100 includes a data storage unit 33 for storing calibration curves, analysis data, etc., generated by the computer unit 32.

The automatic analyzing apparatus 100 includes a display unit 34 for displaying calibration curves, analysis data, etc., generated by the computer unit 32. The automatic analyzing apparatus 100 includes an input unit 35 for enabling inputs for setting one or more parameters to generate a calibration curve, analysis data, etc. for the corresponding test item, inputs for setting test item information for each sample, and so on. The automatic analyzing apparatus 100 includes a system controller unit 36 for controlling the analysis controller unit 31, the computer unit 32, the data storage unit 33, and the display unit 34.

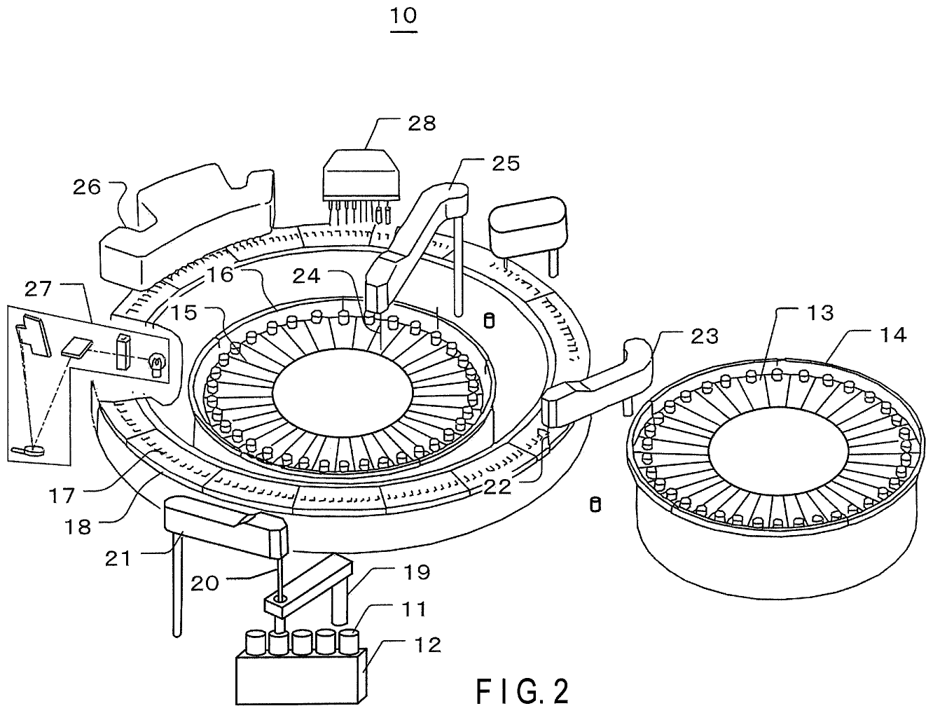

FIG. 2 is a perspective view showing an exemplary structure of the analyzer unit 10. The analyzer unit 10 is provided with one or more sample containers 11 each adapted to contain a sample such as a standard sample, a subject sample, or the like, and includes a sample rack 12 capable of holding more than one sample container 11 in line along the longitudinal direction. The analyzer unit 10 is also provided with one or more first reagent containers 13 each adapted to contain a first reagent which is used in, for example, a single-reagent system or a dual-reagent system as a reagent to react with an ingredient in a sample for the intended test item. The analyzer unit 10 includes a first reagent rack 14 for holding more than one first reagent container 13 in such a manner that the first reagent containers 13 can move.

The analyzer unit 10 is further provided with one or more second reagent containers 15 each adapted to contain a second reagent forming a pair with the first reagent in the dual-reagent system. The analyzer unit 10 includes a second reagent rack 16 for holding more than one second reagent container 15 in such a manner that the second reagent containers 15 can move. The analyzer unit 10 includes circumferentially arranged multiple reaction containers 17, and a reaction disk 18 for holding the reaction containers 17 in such a manner that the reaction containers 17 can make a circling movement.

The analyzer unit 10 includes a piercer unit 19 for piercing a lid of each sample container 11 which may be a blood collection tube with its opening sealed by the lid. The analyzer unit 10 includes a sample dispensing probe 20 for performing a dispensing action including aspiration of a sample from each sample container 11, whose opening has been opened or whose lid has been pierced by the piercer unit 19, and discharge of the sample into the intended reaction container 17. The analyzer unit 10 includes a sample dispensing arm 21 for supporting the sample dispensing probe 20 in such a manner that the sample dispensing probe 20 can move both vertically and in circular fashion.

The analyzer unit 10 includes a first reagent dispensing probe 22 for performing a dispensing action including aspiration of the first reagent from each first reagent container 13 and discharge of this first reagent into the intended reaction container 17. The analyzer unit 10 includes a first reagent dispensing arm 23 for supporting the first reagent dispensing probe 22 in such a manner that the first reagent dispensing probe 22 can move vertically and also in circular fashion. The analyzer unit 10 also includes a second reagent dispensing probe 24 for performing a dispensing action including aspiration of the second reagent from each second reagent container 15 and discharge of this second reagent into the intended reaction container 17. The analyzer unit 10 includes a second reagent dispensing arm 25 for supporting the second reagent dispensing probe 24 in such a manner that the second reagent dispensing probe 24 can move vertically and also in circular fashion.

The analyzer unit 10 includes a stirring unit 26 for stirring a mixture liquid in each reaction container 17 which may be a mixture of the sample and the first reagent or a mixture of the sample, the first reagent, and the second reagent. The analyzer unit 10 includes a measuring unit 27 for performing optical measurement of each stirred mixture liquid. The analyzer unit 10 further includes a washing unit 28 for washing the inside of each reaction container 17 that has undergone the measurement of its mixture liquid.

The measuring unit 27 generates standard data, which may be expressed as, for example, an absorbency level, by measuring a mixture liquid of the standard sample and the reagent or reagents. The measuring unit 27 also generates subject data, which may be expressed as an absorbency level, by measuring a mixture liquid of the subject sample and the reagent or reagents.

Turning back to FIG. 1, the driver unit 30 includes a conveyor mechanism with one or more motors for driving purposes. The driver unit 30 conveys the sample rack 12 in the analyzer unit 10 and stops the conveyance at an aspiration position where the sample dispensing probe 20 can aspirate the sample contained in the sample container 11. The driver unit 30 also includes one or more motors for driving each of the first reagent rack 14 and the second reagent rack 16 so that each of the first reagent containers 13 and the second reagent containers 15 makes a circling movement. The driver unit 30 includes one or more motors for driving the reaction disk 18 so that each reaction container 17 makes a circling movement and stops at an intended stop position.

The driver unit 30 includes one or more motors for driving components in the piercer unit 19. The driver unit 30 includes one or more motors for driving the sample dispensing arm 21, the first reagent dispensing arm 23, and the second reagent dispensing arm 25 for their vertical and rotational motions so that each of the sample dispensing probe 20, the first reagent dispensing probe 22, and the second reagent dispensing probe 24 makes a vertical movement and a circling movement.

The analysis controller unit 31 includes a CPU and storage circuitry. The analysis controller unit 31 operates each component in the analyzer unit 10 by controlling the driver unit 30 based on input information including one or more parameters set for the intended test item according to the inputs via the input unit 35, test item information corresponding to the one or more parameters and set for the standard sample and the subject sample, and so on.

The analysis controller unit 31, in response to an input for starting a calibration via the input unit 35, causes the components of the analyzer unit 10 to perform a calibration including conveyance of the sample rack 12, movement of the first reagent container 13, movement of the second reagent container 15, dispensing of the standard sample, dispensing of the first reagent, dispensing of the second reagent, stirring of the mixture liquid, measurement of the mixture liquid, and so on.

Also, the analysis controller unit 31, in response to an input for starting a test via the input unit 35, causes the components of the analyzer unit 10 to perform a test including conveyance of the sample rack 12, movement of the first reagent container 13, movement of the second reagent container 15, piercing by the piercer unit 19 for the sample container 11 sealed with a lid, dispensing of the subject sample contained in the sample container 11, dispensing of the first reagent, dispensing of the second reagent, stirring of the mixture liquid, measurement of the mixture liquid, and so on.

The computer unit 32 includes a CPU and storage circuitry. The computer unit 32 generates a calibration curve based on standard data and a standard value or values. Here, the standard data has been generated in the calibration by the analyzer unit 10 through measurement of the mixture liquid of the standard sample and the reagent or reagents based on the parameter or parameters for the intended test item. The standard value indicates a concentration of the ingredient for this test item, set for the standard sample.

The computer unit 32 also generates, using the calibration curve for the test item, analysis data expressed as an activity value, a concentration, etc., from subject data that has been generated in the test by the analyzer unit 10 through measurement of the mixture liquid of the subject sample and the reagent or reagents for the test item.

The data storage unit 33 includes a storage which may be, for example, a hard disk drive (HDD), etc. The data storage unit 33 stores various data including data generated by the analyzer unit 10, such as the standard data for the corresponding test item and the subject data, and data prepared and generated by the computer unit 32, such as the calibration curve and the analysis data.

The display unit 34 includes one or more monitors constituted by, for example, a liquid crystal panel. The display unit 34 displays various data including the standard data and the subject data generated by the analyzer unit 10. The display unit 34 also displays the calibration curve and the analysis data, prepared and generated by the computer unit 32.

The input unit 35 include, for example, one or more input devices such as a keyboard, a mouse, buttons, a touch-panel display, and a touch key panel. The input unit 35 enables inputs for setting standard values of the standard samples for respective test items. The input unit 35 also enables inputs for the setting of parameters for the test items, inputs for setting identification information and test item information for the subject samples, and so on.

The system controller unit 36 includes a CPU and storage circuitry, and stores command signals, input information, etc., input via the input unit 35 in the storage circuitry. Based on the input information, the system controller unit 36 controls the entire system by taking total control over the analysis controller unit 31, the computer unit 32, the data storage unit 33, and the display unit 34.

Next, a description will be given of a structure of the piercer unit 19 in the analyzer unit 10.

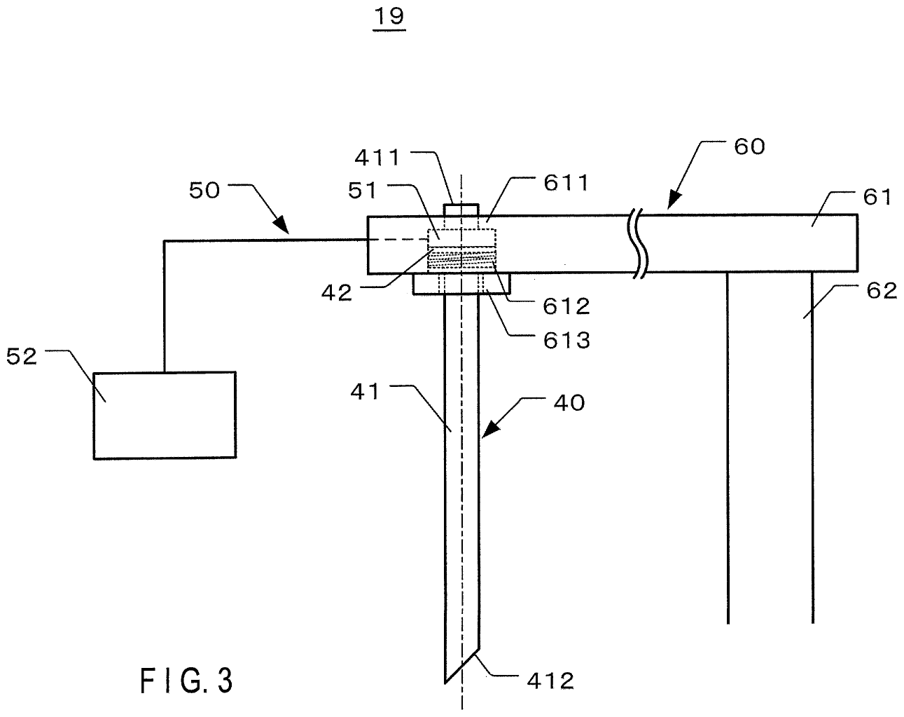

FIG. 3 is a diagram showing an exemplary structure of the piercer unit 19. This piercer unit 19 includes a piercer 40 for piercing a lid of each sample container 11. The piercer unit 19 also includes a detector unit 50 for detecting the piercer 40 penetrating through the lid of the sample container 11. The piercer unit 19 includes a support 60 for supporting the piercer 40 and the detector unit 50.

The piercer 40 is constituted by a tube 41 which is a vertically elongated cylindrical tube, and a flange 42 formed along a part of the outer circumference and near the top of the tube 41. The tube 41 includes an opening 411 at its top. The bottom of the tube 41 is needle-shaped and has an opening 412 formed by cutting the tube 41 at a slant with respect to its central axis. The flange 42 is fixed inside the support 60.

The detector unit 50 includes a sensor 51 and a signal processor 52. The sensor 51 is, for example, an annular load cell adapted to convert a load or force applied to the piercer 40 into an electrical signal. The sensor 51 has an outer diameter which substantially conforms to the outer diameter of the flange 42 of the piercer 40. The sensor 51 is disposed inside the support 60. The signal processor 52 processes the electrical signal or signals at the sensor 51 to calculate an upward pressure applied to the piercer 40 at the time of the piercer 40 being moved downward to press and pierce the lid of the sample container 11. Based on the pressure applied to the piercer 40, the detector unit 50 thus detects an event where the piercer 40 comes in contact with the lid of the sample container 11, an event where the piercer 40 has pierced and penetrated through the lid, and so on.

The support 60 is constituted by an arm 61 and a support shaft 62. The arm 61 holds the sensor 51 of the detector unit 50 and the piercer 40. The support shaft 62 supports the arm 61 in such a manner that the arm 61 can rotate horizontally and move vertically.

The arm 61 includes a vertically penetrating through-hole 611, an elastic member 612 within the through-hole 611, and a retainer 613 adapted to be screw-fitted to the through-hole 611. Note that the through-hole 611 is constituted by a cylindrically shaped upper hole and a cylindrically shaped lower hole having a larger diameter than that of the upper hole.

The diameter of the upper hole of the through-hole 611 is larger than the outer diameter of the tube 41 of the piercer 40 and smaller than the outer diameter of the sensor 51. The portion of the tube 41 higher than the flange 42 is inserted into the upper hole of the through-hole 611 for arrangement.

The diameter of the lower hole of the through-hole 611 is larger than the outer diameter of the sensor 51 and the outer diameter of the flange 42. The sensor 51 and the flange 42 are arranged in the lower hole of the through-hole 611 such that the top face of the sensor 51 contacts the arm 61 and the bottom face of the sensor 51 contacts the top face of the flange 42.

The elastic member 612 is, for example, a coil spring having an outer diameter equal to or smaller than the outer diameter of the flange 42, and an inner diameter larger than the outer diameter of the tube 41. The elastic member 612 is arranged around a part of the outer circumference of the tube 41 below the flange 42. The elastic member 612 is arranged such that its top end contacts the bottom face of the flange 42 and its bottom end contacts the top face of the retainer 613.

The retainer 613 is, for example, a hollow bolt having an inner hole larger than the outer diameter of the tube 41, and a diameter smaller than the outer diameter of the sensor 51 and the outer diameter of the flange 42. The retainer 613 is arranged such that its top face contacts the bottom end of the elastic member 612. Here, the upper portion of the retainer 613 is screw-fitted to the lower hole of the through-hole 611.

In this manner, with the screw-fitting of the retainer 613 to the lower hole of the through-hole 611, the arm 61 is enabled to hold the piercer 40 while a given pressure (“reference pressure”) is applied to the piercer 40 by the elastic member 612.

The support shaft 62 is coupled with the arm 61 and causes the arm 61 to make a vertical movement and a rotational movement according to the vertical driving and rotational driving of the driver unit 30. Such movements of the arm 61 enable the piercer 40 to move downward and upward, i.e., directions for the piercing action, and to also horizontally circle.

FIGS. 1 to 5 will be referred to for describing operations of the piercer unit 19 in the analyzer unit 10 for dispensing a sample.

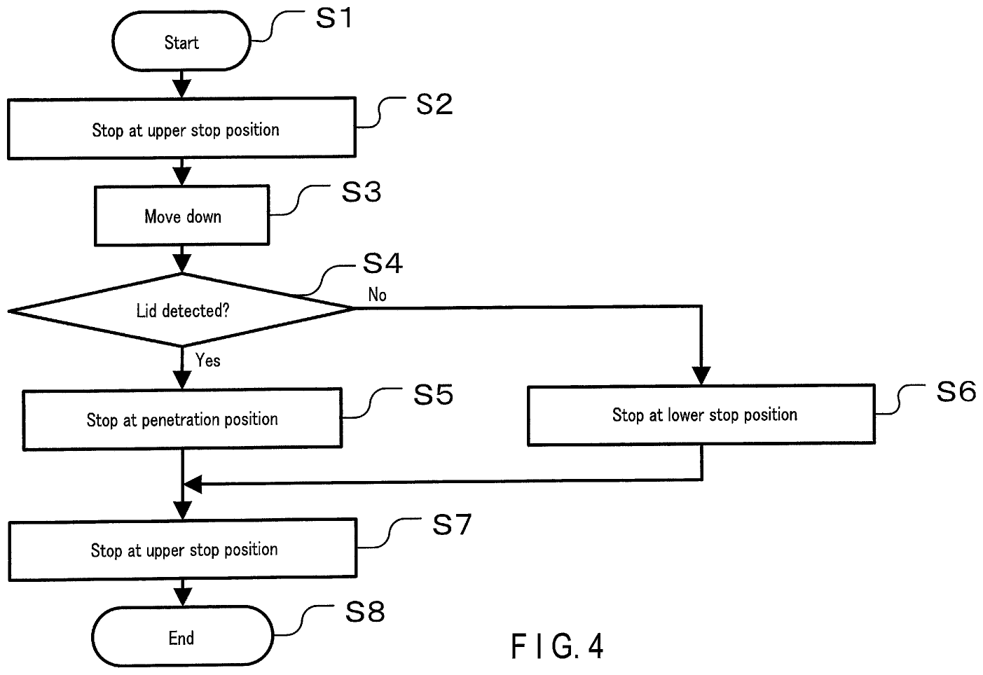

FIG. 4 is a flowchart showing the operations of the piercer unit 19.

In response to an input for starting a test via the input unit 35, the system controller unit 36 instructs, based on pre-input test information, the analysis controller unit 31, the computer unit 32, the data storage unit 33, and the display unit 34 to conduct the test. The analysis controller unit 31 controls the driver unit 30 to operate each component in the analyzer unit 10.

The analysis controller unit 31 causes the sample rack 12 to be conveyed so that each sample container 11 held by the sample rack 12 stops at the aspiration position. Here, the analysis controller unit 31 causes the piercer unit 19 to perform operations from step S1 to step S8 every time another sample container 11 is stopped at the aspiration position.

The piercer unit 19 starts its operations when one sample container 11 stops at the aspiration position (step S1).

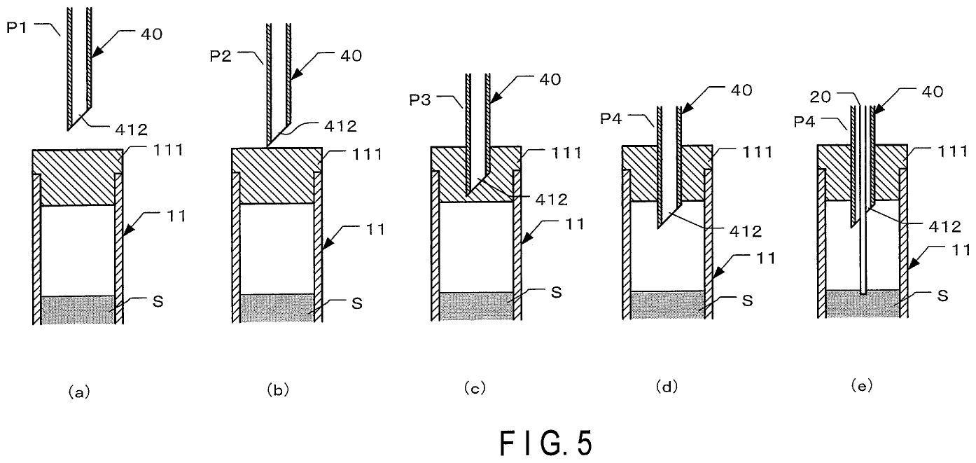

The piercer 40 of the piercer unit 19 horizontally circles from its home position and, as shown in FIG. 5(a), stops at an upper stop position P1 above the sample container 11 located at the aspiration position (step S2).

After step S2, the piercer 40 moves downward from the upper stop position P1 at a constant speed (step S3).

The analysis controller unit 31 controls the piercer 40 for its stop positions based on the distance between the piercer 40 and the upper stop position P1, i.e., how far the piercer 40 has moved down, and measurement by the detector unit 50.

The detector unit 50 measures a pressure applied to the piercer 40 after starting the downward movement from the upper stop position P1. The detector unit 50 thus detects, based on the pressure applied to the descending piercer 40, whether or not a lid is attached to the sample container 11 located at the aspiration position, whether or not the piercer 40 has penetrated through the lid attached to the sample container 11, and so on.

One example of the detector unit 50 detecting a lid of each sample container 11 will be explained. After the piercer 40 initiates the downward movement from the upper stop position P1, the detector unit 50 keeps acquiring, as a measurement, approximately the reference pressure until the piercer 40 contacts a lid 111 of the sample container 11 located at the aspiration position.

When the piercer 40 moves down to a contact position P2 where the bottom end of the piercer 40 contacts the lid 111 of the sample container 11 located at the aspiration position as shown in FIG. 5(b), the detector unit 50 detects an event of the piercer 40 coming into contact with the lid 111 by acquiring a measurement of a pressure change, namely, an increase from the reference pressure.

Accordingly, the detector unit 50 is capable of detecting whether or not the lid 111 is attached to the sample container 11 located at the aspiration position, by acquiring, when the piercer 40 is moving down, a measurement of a pressure change that shows an increase in the pressure applied to the piercer 40 from the reference pressure.

Also, when the piercer 40 moves from the contact position P2 and reaches a break-in position P3 where the bottom end of the piercer 40 intrudes into the internal part of the lid 111 as shown in FIG. 5(c), the detector unit 50 acquires a measurement of a pressure change that shows even an increase from the pressure range from the reference pressure to the pressure at the contact position P2. Subsequently, when the piercer 40 penetrates the lid 111 and reaches a penetration position P4 where the entire opening 412 has just emerged downward from the bottom face of the lid 111 as shown in FIG. 5(d), the detector unit 50 acquires a measurement of a pressure that is higher than the reference pressure and that involves a change from the increased pressure within a predetermined extent.

In this manner, the detector unit 50 is capable of detecting that the piercer 40 has penetrated through the lid 111 of the sample container 11 located at the aspiration position, by acquiring, when the piercer 40 is moving down and after the pressure applied to the piercer 40 is increased from the reference pressure, a measurement of a pressure that is higher than the reference pressure and that involves a change within a predetermined extent.

Also, the detector unit 50 detects an absence of the lid 111 by acquiring a measurement of a pressure that does not deviate from the reference pressure, during the period for the piercer 40 to move down to a predetermined lower stop position below the penetration position P4 and above the surface of the liquid sample in the sample container 11.

Thus, by acquiring a measurement of a pressure applied to the piercer 40 that does not deviate from the reference pressure, it is possible to detect the absence of a lid 111 for the sample container 11 located at the aspiration position.

When the lids 111 attached to the respective sample containers 11 held by the sample rack 12 adopt one common vertical dimension, the information about this dimension of the lid 111 together with the vertical dimension of the opening 412 of the piercer 40 may be input into a setting in advance. In this case, operations may be implemented in such a manner that upon the detector unit 50 detecting the presence of the lid 111 attached to the sample container 11, the analysis controller unit 31 stops the piercer 40 at a position below the contact position P2 by the distance conforming to the sum of the dimension of the lid 111 and the dimension of the opening 412 of the piercer 40, and this position may be used as the penetration position P4 for the piercer 40.

When the sample containers 11 with the respective lids 111 and held by the sample rack 12 have different vertical dimensions, the information about each dimension of the individual sample container 11 and the dimension of the lid 111 attached to this sample container 11, together with the vertical dimension of the opening 412 of the piercer 40, may be input into a setting in advance. In this case, operations may be implemented in such a manner that upon the detector unit 50 detecting the presence of the lid 111 attached to the sample container 11, the analysis controller unit 31 calculates the distance traveled by the piercer 40 from the upper stop position P1 to the contact position P2, calculates the dimension of the sample container 11 located at the aspiration position based on the obtained distance, and retrieves the dimension of the lid 111 corresponding to the sample container 11 of the obtained dimension from the preset information. The analysis controller unit 31 then stops the piercer 40 at a position below the contact position P2 by the distance conforming to the sum of the retrieved dimension of the lid ill and the dimension of the opening 412 of the piercer 40, and this position may be used as the penetration position P4 for the piercer 40.

After step S3, if the presence of the lid 111 attached to the sample container 11 is detected by the detector unit (step S4; Yes), the operation flow advances to step S5. If, on the other hand, the detector unit 50 detects the absence of the lid 111 attached to the sample container 11 (step S4; No), the operation flow advances to step S6.

After “Yes” in step S4, the piercer 40 further moves downward from the contact position P2 at a constant speed, and upon the detector unit 50 detecting the penetration through the lid 111, stops at the penetration position P4 there (step S5).

By stopping the piercer 40 at the penetration position P4 as described above, the opening 412 of the piercer 40 that has entered the sample container 11 is held at a position farthest from the surface of the liquid sample in the sample container 11, and accordingly, it is possible to prevent or suppress the sample in the sample container 11 from coming through the piercer 40 and spattering out of the sample container 11.

After “No” in step S4, the piercer 40 stops at the lower stop position (step S6).

After step S5, the sample dispensing probe 20 horizontally circles from the home position to the position above the piercer 40, and moves downward to pass through the inside of the piercer 40, which is held at the penetration position P4, via the opening 411 and the opening 412. The sample dispensing probe 20 that has passed through the inside of the piercer 40 enters the sample container 11 and aspirates the sample as shown in FIG. 5(e), where the sample is denoted by “S”. Subsequently, the sample dispensing probe 20 moves upward to the position above the piercer 40, moves to the inside of the intended reaction container 17, and discharges the sample.

By stopping the piercer 40 at the penetration position P4 where the entire opening 412 is released to the inside of the sample container 11, the sample dispensing probe 20 is allowed to enter the sample container 11 by passing through the inside of the piercer 40 and to aspirate the sample.

On the other hand, after step S6, the sample dispensing probe 20 makes a horizontal circling movement from the home position to the position above the piercer 40, and moves downward to pass through the inside of the piercer 40 at the lower stop position, via the opening 411 and the opening 412. The sample dispensing probe 20 that has passed through the inside of the piercer 40 enters the sample container 11 and aspirates the sample S. Subsequently, the sample dispensing probe 20 moves upward to the position above the piercer 40, moves to the inside of the intended reaction container 17, and discharges the sample.

Note that the operations after step S6 may instead be implemented in such a manner that the piercer 40 is returned to the home position, with the sample dispensing probe 20 subsequently caused to make a horizontal circling movement from its home position to the position above the piercer 40 and move downward to aspirate the sample in the sample container 11.

After step S5 or step S6, the sample dispensing probe 20 is returned to its home position upon finishing the dispensing action with the sample S in the sample container 11 located at the aspiration position, and the piercer 40 subsequently moves upward and stops at the upper stop position P1 (step S7).

After step S7, the piercer 40 horizontally circles from the upper stop position P1 and stops at its home position, thereby ending the operations of the piercer unit 19 for the sample container 11 which has been set at the aspiration position (step S8).

Additionally, for an exemplary implementation, the sample rack 12 may carry an identifier for showing whether or not it holds one or more sample containers 11 sealed with the lid ill, and a reader device may be disposed for reading this identifier of the sample rack 12 before each sample container 11 is set at the aspiration position. In this case, the piercer unit 19 may be caused to perform the operations in steps S1 to S8 only when the sample rack 12 that holds one or more sample containers 11 sealed with the lid 111 is conveyed and each of such sample containers 11 with the lid 111 is set at the aspiration position.

The foregoing description of the embodiment does not pose a limitation. For example, the detector unit 50 may be replaced with a detector constituted by an imager and an image analyzer. The imager may include an imaging device for acquiring exterior and interior images of the sample container 11 located at the aspiration position. The image analyzer may analyze the image data generated by such imaging action of the imager.

In this case, the sample rack 12 may be provided with one or more windows in the lateral direction, through which the inside of each sample container 11 can be seen from the side. The imager may then acquire the image of the sample container 11 located at the aspiration position from the side and through the window in the sample rack 12. The image analyzer first determines, by analyzing the image data of the sample container 11 generated by the imager, whether or not a lid is attached to the sample container 11. If it is determined that a lid is attached to the sample container 11, the piercer 40 is caused to move down. Acquisition and analysis of moving image data of the sample container 11 are continued, and when the entire opening 412 of the piercer 40 is detected below the lid, the position of the piercer 40 at that time is treated as the penetration position P4 and the piercer 40 is stopped.

According to the embodiment described above, the presence or absence of a lid 111 attached to the sample container 11 located at the aspiration position can be detected by providing the detector unit 50 adapted to measure the pressure applied to the piercer 40 and by acquiring, when the piercer 40 is moving down from the upper stop position P1, a measurement of a pressure change that shows an increase in the pressure applied to the piercer 40 from the reference pressure. Further, an event that the piercer 40 has penetrated through the lid 111 of the sample container 11 located at the aspiration position can be detected by acquiring, when the piercer 40 is moving down and after the pressure applied to the piercer 40 is increased from the reference pressure, a measurement of a pressure that is higher than the reference pressure and that involves a change within a predetermined extent. The piercer 40 is stopped at the penetration position P4 which is a position farthest from the surface of the liquid sample in the sample container 11, so that the sample in the sample container 11 can be prevented or suppressed from rushing into the piercer 40 and spattering out of the sample container 11.

While certain embodiments have been described, they have been presented by way of example only, and are not intended to limit the scope of the inventions. Indeed, the novel embodiments described herein may be embodied in a variety of other forms. Furthermore, various omissions, substitutions, and changes in the form of the embodiments may be made without departing from the spirit of the inventions. The accompanying claims and their equivalents are intended to cover such forms or modifications as would fall within the scope and spirit of the inventions.

1. An automatic analyzing apparatus comprising:
a piercer adapted to pierce a lid which seals an opening of a sample container containing a sample;
a detector unit configured to detect the piercer penetrating through the lid; and
a sample dispensing probe configured to pass through an inside of the piercer that has penetrated through the lid, to enter the sample container, and to aspirate the sample.

2. The automatic analyzing apparatus according to claim 1, wherein
the piercer is configured to move down from an upper stop position above the sample container and to stop at a penetration position where the piercer is detected, by the detector unit, as having penetrated through the lid, and
the sample dispensing probe is configured to pass through the inside of the piercer located at the penetration position so that the sample dispensing probe enters the sample container and aspirates the sample.

3. The automatic analyzing apparatus according to claim 1, wherein the detector unit is configured to detect that the piercer has penetrated through the lid, by measuring force applied to the piercer when the piercer is moving down.

4. The automatic analyzing apparatus according to claim 2, wherein the detector unit is configured to detect that the piercer has penetrated through the lid, by measuring force applied to the piercer when the piercer is moving down,
wherein the detector unit acquires, when the piercer is moving down and after the force applied to the piercer is increased, a measurement of force that is higher than the force applied to the piercer at the upper stop position and that involves a change within a predetermined extent, so that the detector unit detects that the piercer has penetrated through the lid.

5. The automatic analyzing apparatus according to claim 1, wherein the detector unit comprises a load cell configured to convert force applied to the piercer into an electrical signal.

6. The automatic analyzing apparatus according to claim 1, wherein the detector unit is configured to generate image data by imaging the sample container and to detect that the piercer has penetrated through the lid based on the image data.

7. An automatic analyzing apparatus comprising:
a piercer adapted to pierce a lid which seals an opening of a sample container containing a sample;
a detector unit configured to detect contact between the piercer and the lid;
an analysis controller unit configured to cause the piercer to move down, from a contact position where the piercer and the lid are in contact with each other, by a first distance based on information about one or more preset dimensions and stop at a penetration position where the piercer penetrates through the lid; and
a sample dispensing probe configured to pass through an inside of the piercer at the penetration position, to enter the sample container, and to aspirate the sample.

8. The automatic analyzing apparatus according to claim 7, wherein
the piercer is configured to move down from an upper stop position above the sample container, and
the detector unit is configured to detect that the piercer has come into contact with the lid, by measuring force applied to the piercer when the piercer is moving down.

9. The automatic analyzing apparatus according to claim 8, wherein the detector unit uses, to detect that the piercer has come into contact with the lid, a change in the force applied to the piercer when the piercer is moving down, the change being an increase.

10. The automatic analyzing apparatus according to claim 7, wherein the first distance conforms to a sum of a vertical dimension of a bottom opening of the piercer and a vertical dimension of the lid.

11. The automatic analyzing apparatus according to claim 7, wherein
the one or more preset dimensions comprises a vertical dimension of the sample container, a vertical dimension of the lid attached to the sample container, and a vertical dimension of a bottom opening of the piercer, and
the analysis controller unit is configured to calculate the vertical dimension of the sample container based on a second distance traveled by the piercer from an upper stop position above the lid attached to the sample container to the contact position, wherein the first distance conforms to a sum of the vertical dimension of the lid attached to the sample container and the vertical dimension of the bottom opening of the piercer.

12. A method comprising:
piercing, by a piercer, a lid which seals an opening of a sample container containing a sample;
detecting, by a detector unit, that the piercer has penetrated through the lid by measuring force applied to the piercer when the piercer is moving down; and
causing a sample dispensing probe to pass through an inside of the piercer that has penetrated through the lid, to enter the sample container, and to aspirate the sample.
